(19) United States
(12) Patent Application Publication
(10) Pub. No.: US 2022/0345003 A1
(43) Pub. Date: Oct. 27, 2022

(54) Electronic Controller, Electric Drive Device, and Electric Power Steering Apparatus

(71) Applicant: Hitachi Astemo, Ltd., Hitachinaka-shi, Ibaraki (JP)

(72) Inventors: Tomohiro FUKUDA, Hitachinaka-shi (JP); Haruaki MOTODA, Hitachinaka-shi (JP)

(21) Appl. No.: 17/763,345

(22) PCT Filed: Aug. 14, 2020
(86) PCT No.: PCT/JP2020/030854

§ 371 Date: Mar. 24, 2022

(30) Foreign Application Priority Data
Sep. 26, 2019 (JP) 2019-176096

(51) Int. Cl. H02K 5/22; H02K 11/33; B62D 5/04

(52) U.S. Cl. CPC H02K 5/225; H02K 11/33; B62D 5/0463; H02K 2211/03

(57) ABSTRACT

Provided are an electronic controller, an electric drive device, and an electric power steering apparatus that allow miniaturization and facilitate assembling work. An electronic controller 9 includes a board 31 and a connector assembly 41. The board 31 has connection holes 32 into which coil wires are inserted. The connector assembly 41 includes a flat plate portion 42 that leaves one side in the axial direction of an area of the board 31 open, the area including the connection holes, while covering a part of the board 31, and connector housings 44 provided on the flat plate portion 42, the connector housings 44 each allowing a terminal of an external device to be inserted therein along the axial direction.

### TECHNICAL FIELD

The present invention relates to an electronic controller, an electric drive device including the electronic controller and an electric motor unit, and an electric power steering apparatus including the electric drive device.

### BACKGROUND ART

An automobile is equipped with an electric power steering apparatus that generates torque by a motor to serve as a mechanism that assists in steering. A conventional technique for providing this type of apparatus, for example, is described in PTL 1.

PTL 1 describes a technique for providing a device that includes a cylindrical motor case forming an outer frame, a stator disposed radially inside the motor case and wound with windings constituting a plurality of current phases, and a rotor disposed radially inside the stator and supported rotatably. PTL 1 describes also a technique for providing a device that includes a shaft, a heat sink disposed in the axial direction of a motor case and having a plurality of columnar portions separated from each other, and a semiconductor module disposed on the columnar portions such that one drive system corresponds to one columnar portion.

### CITATION LIST

### Patent Literature

PTL 1: JP 2011-176998 A

### SUMMARY OF INVENTION

### Technical Problem

However, according to the technique described in PTL 1, the direction of inserting a terminal of an external device in a connector is set perpendicular to the axial direction of the device. As a result, according to the technique described in PTL 1, the connector sticks out in the direction perpendicular to the axial direction of the device, thus leading to an increase in the overall size of the device. Besides, improving assembling efficiency of an electronic controller has been in demand for years.

The present invention has been conceived in view of the above problems, and it is an object of the invention to provide an electronic controller, an electric drive device, and an electric power steering apparatus that allow miniaturization and make assembling work easy.

### Solution to Problem

In order to solve the above problems and achieve the object, an electronic controller includes a board and a connector assembly. The board carries an electronic circuit and is placed on a pedestal disposed on one side in an axial direction of an electric motor unit. The connector assembly is disposed on one side in the axial direction of the board.

The board has a connection hole in which a coil wire of the electric motor unit is inserted. The connector assembly includes: a flat plate portion that leaves one side in the axial direction of an area of a board open, the area including the connection hole, while covering a part of the board; and a connector housing provided on the flat plate portion, the connector housing allowing a terminal of an external device to be inserted therein along the axial direction.

An electric drive device includes: an electric motor unit having an electric motor, a motor housing that houses the electric motor, and a pedestal provided on one end in the axial direction of the motor housing; and an electronic controller attached to the electric motor unit, the electronic controller controlling the electric motor unit. This electronic controller is the electronic controller described above.

An electric power steering apparatus includes an electric drive device that provides auxiliary torque to assist in operating/turning a steering wheel. This electric drive device is the electric drive device described above.

### Advantageous Effects of Invention

According to the electronic controller, the electric drive device, and the electric power steering apparatus that have the above-described configurations, miniaturization can be achieved as assembling work is easily performed.

### BRIEF DESCRIPTION OF DRAWINGS

FIG. 1 is a perspective view of an electric power steering apparatus according to an embodiment.

FIG. 2 is an exploded perspective view of an electronic controller according to the embodiment.

FIG. 3 is a perspective view of a board of the electronic controller and a pedestal of an electric motor unit according to the embodiment.

FIG. 4 is a plan view of the board and a connector assembly of the electronic controller according to the embodiment.

FIG. 5 is a perspective view of the electronic controller and the pedestal of the electric motor unit according to the embodiment.

FIG. 6A is a perspective view showing a state in which the board of the electronic controller according to the embodiment is placed on the pedestal of the electric motor unit, and FIG. 6B is an explanatory view showing end processing on coil wires.

FIG. 7 is a cross-sectional view showing a first caulking portion on a cover put on the electronic controller according to the embodiment.

FIG. 8 is a cross-sectional view showing a second caulking portion on the cover put on the electronic controller according to the embodiment.

### DESCRIPTION OF EMBODIMENTS

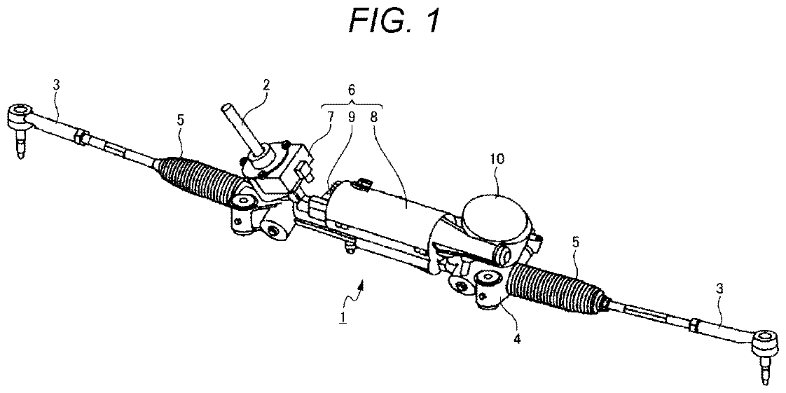

Embodiments of an electronic controller, an electric drive device, and an electric power steering apparatus will now be described with reference to FIGS. 1 to 8. In the drawings, the same members will be denoted by the same reference signs.

### 1. Embodiment 1-1. Configuration of Electric Power Steering Apparatus

A configuration of an electric power steering apparatus according to an embodiment (which will hereinafter be referred to as “this example”) will first be described with reference to FIG. 1.

FIG. 1 is a perspective view of the electric power steering apparatus.

The apparatus shown in FIG. 1 is an electric power steering apparatus for steering driving wheels (usually, front wheels) of an automobile. As shown in FIG. 1, an electric power steering apparatus 1 includes a steering shaft 2, tie rods 3, a rack housing 4, rubber boots 5, an electric drive device 6, and a gear 10.

One end in the axial direction of the steering shaft 2 is connected to a steering wheel (not illustrated). At the other end in the axial direction of the steering shaft 2, a pinion (not illustrated) is disposed. The pinion meshes with a rack (not illustrated) extending in the width direction of a vehicle body. The tie rods 3 for steering the driving wheels of the automobile toward the left and right are connected respectively to both ends of the rack. The rack is covered with the rack housing 4. Between the rack housing 4 and the tie rods 3, the rubber boots 5 are each provided.

The electric drive device 6 provides auxiliary torque for assisting in operating/turning a steering wheel. The electric drive device 6 includes a torque sensor 7, an electric motor unit 8 serving as a drive unit, and an electronic controller (electronic control unit or ECU) 9.

The torque sensor 7 detects the rotation direction and the rotation torque of the steering shaft 2.

A plurality of parts of the outer periphery of electric motor unit 8, the parts being on an output shaft side, are connected to the gear 10 via bolts (not illustrated). Based on a detection value from the torque sensor 7, the electric motor unit 8 gives a steering assist force to the rack via the gear 10. At an end of electric motor unit 8 that is opposite to the output shaft side, the electronic controller 9 is provided. The electronic controller 9 controls an electric motor disposed in the electric motor unit 8, thus controlling driving of the electric motor unit 8. The electric motor unit 8 and the electronic controller 9 make up an electric drive unit. The torque sensor 7 may be provided as a separate sensor independent of the electric drive device 6.

When the steering wheel is operated, the steering shaft 2 is rotated clockwise or counterclockwise. At this time, the torque sensor 7 detects the rotation direction and the rotation torque of the steering shaft 2. Based on a detection value from the torque sensor 7, the electronic controller 9 calculates a drive operation amount of the electric motor unit 8.

Based on the calculated drive operation amount, the electronic controller 9 drives the electric motor unit 8 through a switching element 101 mounted on a board 31, which will be described later. As a result, the output shaft of the electric motor unit 8 is rotated in such a way as to drive the steering shaft 2 in the same direction as the operation direction. The rotation of the output shaft of the electric motor unit 8 is transmitted from the pinion (not illustrated) to the rack via the gear 10. Hence the automobile is steered.

### 1-2. Example of Configuration of Electric Drive Unit

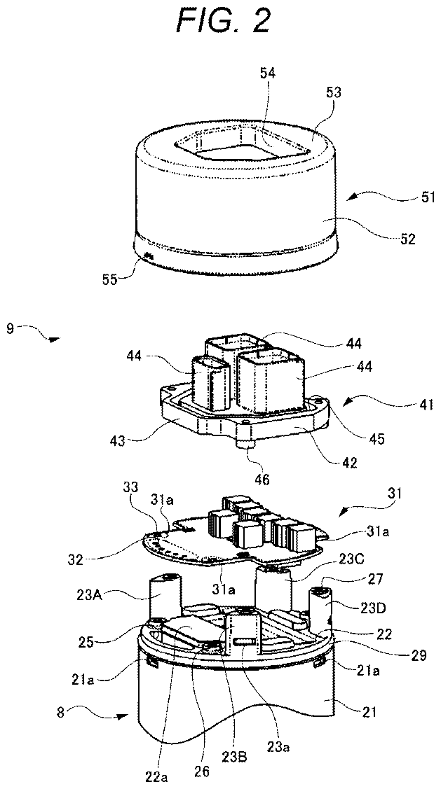

An example of detailed configurations of the electric motor unit 8 and the electronic controller 9 will then be described with reference to FIGS. 2 to 4.

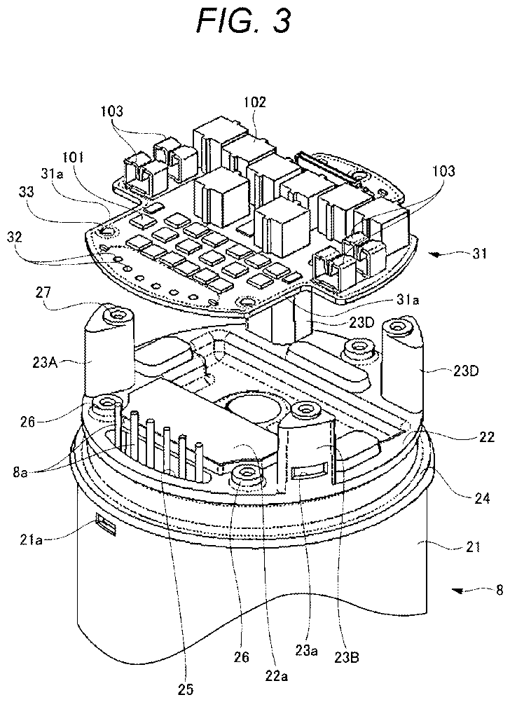

FIG. 2 is an exploded perspective view of the electronic controller 9. FIG. 3 is a perspective view of the board 31 of the electronic controller 9 and a pedestal 22 of the electric motor unit 8.

As shown in FIG. 2, the electric motor unit 8 includes a motor housing 21, i.e., an enclosure, an electric motor, and the pedestal 22. The motor housing 21 and the pedestal 22 are formed using, for example, an aluminum alloy or the like. The motor housing 21 is formed into a cylindrical shape.

The motor housing 21 has a cylindrical hole in which the electric motor is placed.

To one end in the axial direction of the motor housing 21, the pedestal 22 is fixed. To this pedestal 22, the electronic controller 9 is attached. The other end in the axial direction of the motor housing 21 is on the output shaft side of the electric motor unit 8.

The electronic controller 9 includes the board 31 carrying electronic components, the connector assembly 41, and a cover 51 covering the board 31 and a part of the connector assembly 41. A detailed configuration of the electronic controller 9 will be described later.

FIG. 3 is a perspective view of the pedestal 22 and the board 31.

As shown in FIG. 3, a plurality of second caulking recesses 21a are formed on the outer peripheral surface on the one end in the axial direction of the motor housing 21. The plurality of second caulking recesses 21a are arranged circumferentially at intervals on the outer peripheral surface of the motor housing 21. The second caulking recesses 21a are formed by recessing the outer peripheral surface of the motor housing 21 inward in a radial direction. The cover 51 of the electronic controller 9 is fitted in these second caulking recesses 21a by caulking.

The pedestal 22 is disposed in such a way as to close an opening on the one end in the axial direction of the motor housing 21. The pedestal 22 has a plurality of bearing surfaces 22a, a plurality of supports 23A, 23B, 23C, and 23D (four supports 23A, 23B, 23C, and 23D in this example), and a coil wire opening 25.

The bearing surfaces 22a are formed on one end face in the axial direction of the pedestal 22, the one end face being opposite to the motor housing 21. The bearing surfaces 22a are surfaces projecting from the pedestal 22 toward one side in the axial direction. On the bearing surfaces 22a, the board 31 is placed. Near the bearing surface 22a on the one end face of the pedestal 22, board fixing portions 26 are formed. Fastening screws (not illustrated) for fixing the board 31 are screwed into the board fixing portions 26.

The coil wire opening 25 is formed near the outer edge of the pedestal 22. The coil wire opening 25 is a through-hole penetrating the pedestal 22 from its one end face to the other end face opposite thereto. A plurality of coil wires 8A (six coil wires 8A in this example) of the electric motor are inserted through the coil wire opening 25.

The plurality of supports 23A, 23B, 23C, and 23D are arranged on the outer edge of the one end face of pedestal 22. The supports 23A, 23B, 23C, and 23D project from the one end face of the pedestal 22 toward the one side in the axial direction. The projection height of the supports 23A, 23B, 23C, and 23D is set higher than the projection height of the bearing surfaces 22a. On the front ends of the supports 23A, 23B, 23C, and 23D, connector fixing holes 27, into which fastening screws (not illustrated) for fixing the connector assembly 41 are screwed, are each formed.

On outer side surfaces of the supports 23A, 23B, 23C, and 23D, first caulking recesses 23a are each formed. The first caulking recesses 23a are formed by recessing the supports 23A, 23B, 23C, and 23D inward. The cover 51 is fitted into the first caulking recesses 23a by caulking.

The first support 23A is disposed close to one end in the longitudinal direction of the coil wire opening 25, with a gap formed between the first support 23A and the one end. The second support 23B is disposed close to the other end in the longitudinal direction of the coil wire opening 25, with a gap formed between the second support 23B and the other end. The coil wire opening 25 is, therefore, disposed between the first support 23A and the second support 23B. In addition, the periphery of the coil wire opening 25 is left open.

On the other end of pedestal 22 that is closer to the motor housing 21, an O-ring fitting portion 24 is formed. The O-ring fitting portion 24 is formed continuously on the outer peripheral surface of the pedestal 22 along its circumferential direction.

As shown in FIG. 2, an O-ring 29 is fitted to the O-ring fitting portion 24. The O-ring 29 is thus disposed between the first caulking recesses 23a and the second caulking recesses 21a. It should be noted that the O-ring fitting portion 24 may be formed on the outer peripheral surface of the motor housing 21 so that the O-ring 29 is fitted to the motor housing 21.

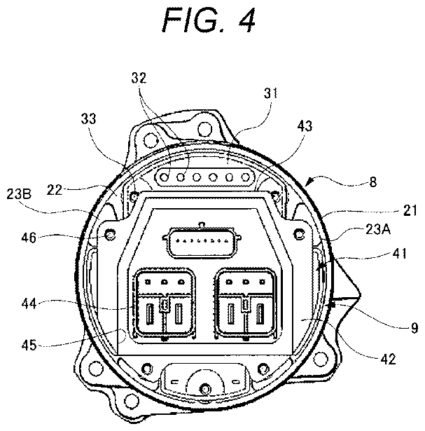

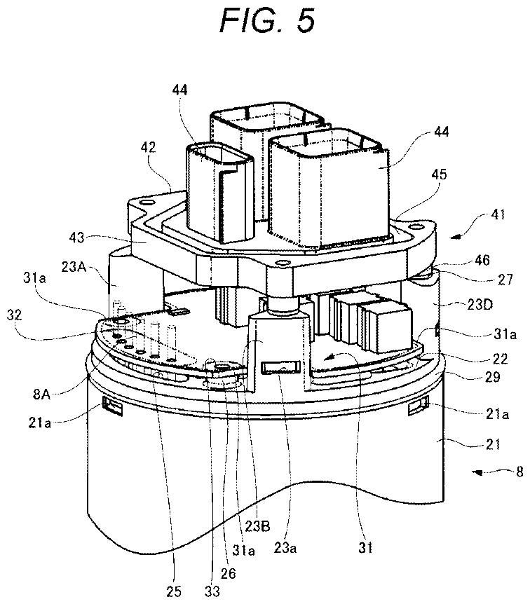

FIG. 4 is a plan view of the electronic controller 9, and FIG. 5 is a perspective view of the electronic controller 9 and the pedestal 22 of the electric motor unit 8. FIG. 5 shows a state of the cover 51 being removed.

The board 31 carries a power conversion circuit made up of switching elements 101, capacitors 102, terminal connections 103, a magnetic sensor (not illustrated), and a set of an FS relay and a power choke coil (not illustrated). To the terminal connections 103, a power supply terminal and a GND terminal, which project from the connector assembly 41, are electrically connected.

The switching elements 101 convert direct current into three-phase alternating current. The capacitors 102, which are provided as aluminum electrolytic capacitors or the like, perform charging/discharging to suppress voltage fluctuations, such as switching noise. The magnetic sensor (not illustrated) is a sensor that detects a rotation angle of the electric motor. The FS relay of the set of the FS relay and the power choke coil (not illustrated) is a circuit component that cuts off a current flow in the electric motor when the electronic controller 9 fails, and the power choke coil is a circuit component that suppresses a radio wave generated as switching noise.

The board 31 carries also an integrated circuit or the like that calculates a control signal for controlling the electric motor unit 8. The board 31 thus functions as a power supply board and as a control board as well. As a result, the number of boards included in the electronic controller 9 can be reduced to one.

The board 31 is formed substantially into a circular shape with four cutouts 31a formed thereon. The cutouts 31a are each formed at positions at which the cutouts 31a face the supports 23A, 23B, 23C, and 23D, when the board 31 is placed on the bearing surfaces 22a of the pedestal 22. This prevents the board 31 and the supports 23A, 23B, 23C, and 23D from interfering with each other. In addition, aligning the cutouts 31a of the board 31 with the supports 23A, 23B, 23C, and 23D facilitates positioning the board 31 relative to the pedestal 22.

The board 31 has a plurality of connection holes 32 (six connection holes 32 in this example) and fixing holes 33. The plurality of connection holes 32 are formed on a part of the outer edge of the board 31. The plurality of connection holes 32 are arranged at equal intervals along the outer edge of the board 31. As shown in FIG. 5, when the board 31 is placed on the pedestal 22, the coil wires 8A are put through the connection holes 32. The coil wires 8A and the board 31 are connected by, for example, a spot flow soldering method.

Hence the board 31 and the electric motor are electrically connected to each other.

When the board 31 is placed on pedestal 22, the fixing holes 33 face the board fixing portions 26 of the pedestal 22. Fastening screws (not illustrated) are inserted into the fixing holes 33, and are screwed into the board fixing portions 26. This fixes the board 31 to the pedestal 22.

On the surface of board 31 that is opposite to the pedestal 22, the connector assembly 41 is disposed. The connector assembly 41 includes a flat plate portion 42, and a plurality of connector housings 44 (three connector housings 44 in this example).

The connector assembly 41 includes also the power supply terminal and the GND terminal (not illustrated) which project from the flat plate portion 42 and connect to the terminal connections 103 of the board 31. By connecting together the terminal connections 103 and the power supply terminal and GND terminal (not illustrated), the board 31 and the connector assembly 41 are electrically connected to each other.

The flat plate portion 42 is of a substantially flat plate shape. As shown in FIGS. 4 and 5, the flat plate portion 42 covers almost the whole of the surface of board 31 that is opposite to the electric motor unit 8. As shown in FIG. 5, the flat plate portion 42 is placed on the supports 23A, 23B, 23C, 23D of the pedestal 22.

The flat plate portion 42 has a plurality of connector-side fixing portions 46. The plurality of connector-side fixing portions 46 each face the connector fixing holes 27, when the flat plate portion 42 is placed on the supports 23A, 23B, 23C, and 23D. Fastening screws (not illustrated) are inserted into the connector-side fixing portions 46, and are screwed into the connector fixing holes 27. This fixes the connector assembly 41 to the pedestal 22.

As shown in FIG. 4, the flat plate portion 42 has an open surface portion 43. The open surface portion 43 is formed by cutting out a part of the flat plate portion 42. The open surface portion 43 is located closer to the connection holes 32 of the board 31 when the board 31 is covered with the flat plate portion 42. The open surface portion 43 leaves one side in the axial direction of an area of the board 31 where the connection holes 32 is formed open, thus forming a space into which a tool can be inserted.

On one surface of the flat plate portion 42, the one surface being opposite to a counter surface of flat plate portion 42 that is counter to the board 31, the connector housings 44 are provided. The connector housings 44 project along the axial direction of the electronic controller 9, from the one surface of the flat plate portion 42 toward the side opposite to the board 31.

The connector housings 44 are each formed into a cylindrical shape that encircles a connector terminal. In a cylindrical hole of the connector housing 44, a connection terminal of an external device is inserted. The direction of insertion of the connection terminal of the external device is parallel to the axial direction of the electronic controller 9 and the motor housing 21.

As shown in FIG. 4, in a view in which the motor housing 21 is seen in the axial direction, the plurality of connector housings 44 are within a projection plane of the motor housing 21 and the pedestal 22.

In this manner, the plurality of connector housings 44 do not stick out in the radial direction perpendicular to the axial direction of the motor housing 21 and the pedestal 22. This allows miniaturization of the electronic controller 9 and the electric drive unit.

The flat plate portion 42 has a groove 45. The groove 45 is formed continuously in such a way as to encircle the plurality of connector housings 44. The groove 45 is formed by recessing the flat plate portion 42 from its one surface toward the opposite surface.

As shown in FIG. 2, the cover 51 is formed substantially into a cylindrical shape. On the other end in the axial direction of the cover 51, an open surface is formed. The cover 51 includes a side surface 52 and a main surface 53. The main surface 53 is located on one end in the axial direction of the cover 51. The main surface 53 has an opening 54 from which the connector housings 44 of the connector assembly 41 project.

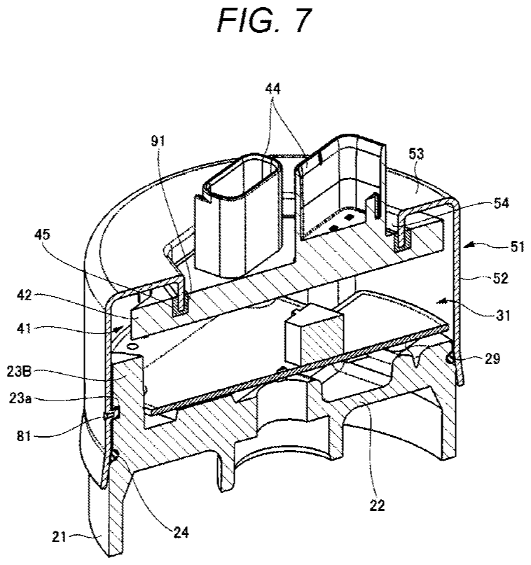

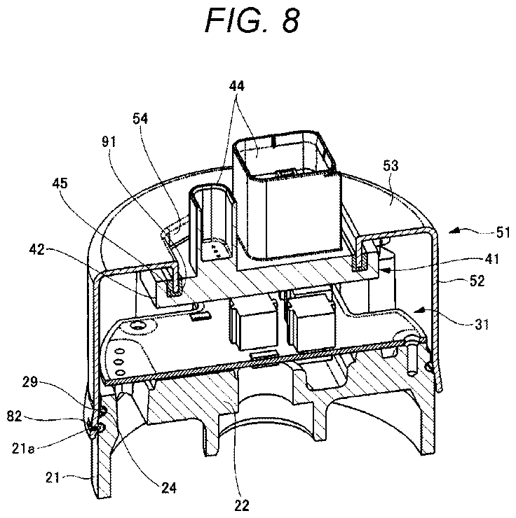

The opening 54 sinks almost vertically from the main surface 53, and has a front end facing the other end in the axial direction. The front end of the opening 54 is fitted into the groove 45 of the connector assembly 41 (see FIGS. 7 and 8).

The other end in the axial direction of the side surface 52 is counter to the outer peripheral surface of one end side in the axial direction of the motor housing 21. The other end of the side surface 52 has positioning recesses 55. The positioning recesses 55 are formed by recessing the side surface 52 inward. The positioning recesses 55 are fitted into the second caulking recesses 21a of the motor housing 21. This facilitates positioning of the cover 51 relative to the motor housing 21 and the pedestal 22.

### 2. Assembling Procedure for Electronic Controller

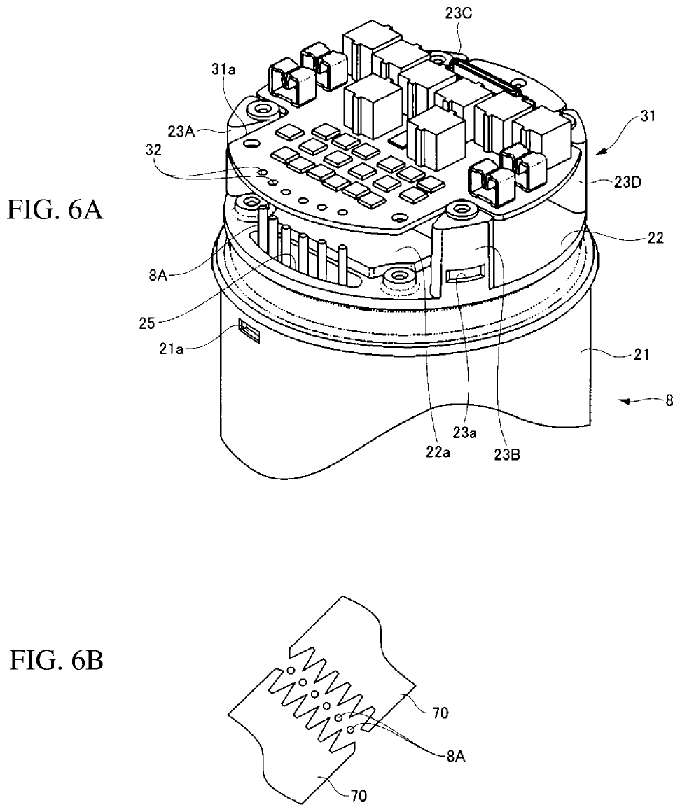

An assembling procedure for the electronic controller 9 having the above-described configuration will then be described with reference to FIGS. 6 to 8. FIG. 6A is an explanatory view showing a state in which the board 31 is placed on the pedestal 22, and FIG. 6B is an explanatory view showing end processing on the coil wires 8A. In FIG. 6A, the connector assembly 41 is not illustrated.

First, the connector assembly 41 is superposed on the board 31, and the power supply terminal and GND terminal (not illustrated) of the connector assembly 41 are connected to the terminal connections 103. The board 31 and the connector assembly 41 are then coupled together.

Subsequently, the board 31 coupled with the connector assembly 41 is placed on the bearing surfaces 22a of the pedestal 22, as shown in FIG. 6A. Then, the coil wires 8A are put through the connection holes 32 of the board 31. Because the cutouts 31a are formed on the parts of board 31 that are counter to the supports 23A, 23B, 23C, and 23D, the board 31 can be easily aligned with the pedestal 22.

The first support 23A and the second support 23B are arranged near the coil wire opening 25 such that a gap is formed between each of the first and second supports 23A and 23B and the coil wire opening 25. As a result, a space allowing comb-teeth jigs 71 (see FIG. 6B) to be inserted therein is formed around the coil wire opening 25.

Thus, as shown in FIG. 6B, the plurality of coil wires 8A projecting out of the coil wire opening 25 are sandwiched between a pair of the comb-teeth jigs 71 and 71. This corrects the position of the projecting coil wires 8A to a proper position and holds the coil wires 8A at the proper position. Being held at the proper position, the coil wires 8A can be easily inserted into the connection holes 32 of the board 31. In addition, because the plurality of coil wires 8A of the electric motor are collectively arranged at one part of the pedestal 22, work of inserting the coil wires 8A into the connection holes 32 can be carried out easily.

Further, as shown in FIG. 4, the open surface portion 43 is formed by cutting out a part of the flat plate portion 42 of the connector assembly 41, thus leaving the one side in the axial direction of the area of board 31 where the connection holes 32 are formed open. This prevents a case where the coil wires 8A and the connection holes 32 are concealed under the connector assembly 41, and therefore allows the coil wires 8A to be inserted easily into the connection holes 32.

Hence, as shown in FIG. 5, the board 31 is placed on the bearing surfaces 22a of the pedestal 22, and the connector assembly 41 is supported by the supports 23A, 23B, 23C, and 23D. Subsequently, fastening screws are inserted in the connector-side fixing portions 46 and are screwed into the connector fixing holes 27. This fixes the connector assembly 41 to the pedestal 22. Meanwhile, fastening screws are inserted into the fixing holes 33 and are screwed into the board fixing portions 26. This fixes the board 31 to the pedestal 22.

Subsequently, the coil wires 8A are connected to the board 31 by, for example, the spot flow soldering method. Hence the board 31 and the electric motor are electrically connected to each other. It should be noted that methods of connecting the coil wires 8A to the board 31 are not limited to the spot flow soldering method but include other various methods, such as a method using a solder iron for soldering and a method of melting solder by laser irradiation.

As described above, on the one side in the axial direction of the area of board 31 where the connection holes 32 are formed, the space allowing a tool to be inserted therein is formed. A tool for spot flow soldering, a solder iron, and the like can be inserted easily in the space, and therefore work of connecting the board 31 and the coil wires 8A together can be carried out easily. This facilitates assembling work of assembling the electronic controller 9 and the electric drive unit. In addition, increasing the size of the board 31 and the pedestal 22 to provide a space for tool insertion is unnecessary, which allows miniaturization of the electronic controller 9 and the electric drive unit.

In connection work using a solder iron or a laser, the plurality of coil wires 8A are connected to the board 31 one by one. In the electronic controller 9 and the electric drive unit of this example, in contrast, the plurality of coil wires 8A are collectively arranged at one part. Because of this arrangement, the spot flow soldering method can be applied to work of connecting the coil wires 8A and the board 31 together. Thus, the plurality of coil wires 8A can be simultaneously connected to the board 31 by the spot flow soldering method. As a result, a time required for work of connecting the board 31 and the coil wires 8A together can be reduced, which facilitates work of assembling the electronic controller 9 and the electric drive unit.

It should be noted that work of fixing the board 31 and the connector assembly 41 to the pedestal 22 may be carried out after the coil wires 8A are connected to the board 31.

Subsequently, the cover 51 is put on the connector assembly 41 and the board 31. The O-ring 29 is fitted in advance to the O-ring fitting portion 24 of the pedestal 22. FIGS. 7 and 8 are cross-sectional views showing a state in which the cover 51 is put on the connector assembly 41 and the board 31. As shown in FIGS. 7 and 8, the connector housings 44 project out of the opening 54 of the cover 51 as the front end of the opening 54 is fitted into the groove 45 of the connector assembly 41.

The groove 45 is filled with a sealant 91, which bonds the groove 45 and the opening 54 together. The sealant 91 thus fills up a gap between the groove 45 and the front end of the opening 54, thereby preventing entry of water from the opening 54 to the interior of the cover 51. A rubber gasket or the like may be used in place of the sealant 91.

Subsequently, as shown in FIG. 7, the side surface 52 of the cover 51 is pushed into the first caulking recesses 23a. This causes the side surface 52 to plastically deform, thus forming first caulking portions 81 on the side surface 52. In the same manner, as shown in FIG. 8, the side surface 52 of the cover 51 is pushed into the second caulking recesses 21a. This causes the side surface 52 to plastically deform, thus forming second caulking portions 82 on the side surface 52. In this manner, the cover 51 is subjected to the caulking process on its two parts, i.e., the first caulking portions 81 and the second caulking portions 82, which fixes the cover 51 to the pedestal 22 and the motor housing 21. Hence the electronic controller 9 is assembled.

The first caulking portions 81 are formed on one side in the axial direction with respect to the O-ring 29 (see FIG. 7), while the second caulking portions 82 are formed on the other side in the axial direction with respect to the O-ring 29 (see FIG. 8). The O-ring 29 is, therefore, sandwiched between the first caulking portions 81 and the second caulking portions 82.

By carrying out the caulking process of the cover 51 on its first caulking portions 81, outward expansion in the radial direction of the other end of cover 51 in the axial direction with respect to the O-ring 29 is suppressed by the second caulking portions 82 subjected to the caulking process. Likewise, by carrying out the caulking process of the cover 51 on its the second caulking portions 82, outward expansion in the radial direction of the one end of the cover 51 in the axial direction with respect to the O-ring 29 is suppressed by the first caulking portions 81 subjected to the caulking process.

As a result, the inner wall surface of the side surface 52 of the cover 51 can certainly be brought into close contact with the O-ring 29. This prevents entry of water from the other end side of the side surface 52 to the interior of the cover 51, thus improving a waterproofing effect.

In addition, because the cover 51 is fixed by the caulking process without using fastening screws, providing a flange or a projection for fitting fastening screws to the motor housing 21 or the pedestal 22 is unnecessary. This allows miniaturization of the electronic controller 9 and the electric drive unit.

Using a liquid gasket (FIPG: Formed In Place Gasket) as a means for fixing and waterproofing the cover 51 maybe a conceivable option. However, using the liquid gasket requires equipment for curing the liquid gasket, which takes much time to cure. Besides, the liquid gasket might peeled away from the cover 51 or the motor housing 21.

In contrast, waterproofing by the O-ring 29 and fixing the cover 51 by caulking makes equipment for curing the liquid gasket unnecessary. It also reduces a time required for fixing the cover 51, thus facilitating work of fixing the cover 51.

The example in which the first caulking recesses 23a are formed on the supports 23A, 23B, 23C, and 23D of the pedestal 22 has been described above. Formation of the first caulking recesses 23a is, however, is not limited to this example. The first caulking recesses 23a may be formed on the side surface of the pedestal 22 or may be formed on the motor housing 21.

It should be noted that the present invention is not limited to the embodiment described above and illustrated in the drawings, and that the invention may be modified into various forms within a range that does not deviate from the substance of the invention described in the claims.

In this specification, such terms as “parallel” and “perpendicular” are used. These terms should not be strictly interpreted as exact “parallel” and “perpendicular”, but should be interpreted as wider concepts that include “parallel” and “perpendicular” and “substantially parallel” and “substantially perpendicular” as well, which are substantially equivalent to “parallel” and “perpendicular” in terms of functional range.

### REFERENCE SIGNS LIST

1 electric power steering apparatus
2 steering shaft
3 tie rod
4 rack housing
5 rubber boot
6 electric drive device
7 torque sensor
8 electric motor unit
8A coil wire
9 electronic controller
10 gear
21 motor housing
21a second caulking recess
22 pedestal
22a bearing surface
23A, 23B, 23C, 23D support
23a first caulking recess
24 O-ring fitting portion
25 coil wire opening
26 board fixing portion
27 connector fixing hole
29 O-ring
31 board
32 connection hole
33 fixing hole
41 connector assembly
42 flat plate portion
43 open surface portion
44 connector housing
45 groove
46 connector-side fixing portion
51 cover
52 side surface
53 main surface
54 opening
55 recess
71 comb-teeth jig
81 first caulking portion
82 second caulking portion
91 sealant
101 switching element
102 capacitor
103 terminal connection

1. An electronic controller comprising:
a board carrying an electronic circuit, the board being placed on a pedestal disposed on one side in an axial direction of an electric motor unit; and
a connector assembly disposed on one side in the axial direction of the board,
wherein the board has a connection hole in which a coil wire of the electric motor unit is inserted, and
the connector assembly includes:
a flat plate portion that leaves one side in the axial direction of an area of the board open, the area including the connection hole, while covering a part of the board; and
a connector housing provided on the flat plate portion, the connector housing allowing a terminal of an external device to be inserted in the connector housing along the axial direction.

2. The electronic controller according to claim 1, wherein the flat plate portion is provided with an open surface portion that leaves one side in the axial direction of an area of the board open, the area including the connection hole, to form a space in which a tool for connecting the board to the coil wire is inserted.

3. The electronic controller according to claim 1, wherein the coil wire is connected to the board by a spot flow soldering method.

4. The electronic controller according to claim 1, wherein the connector housing is located within a projection plane of an enclosure of the electric motor unit when the electric motor unit is seen from one side in the axial direction.

5. The electronic controller according to claim 1, wherein the board carries:
a power conversion circuit that converts power; and
an integrated circuit that calculates a control signal for controlling the electric motor unit.

6. The electronic controller according to claim 1, wherein the connection hole is formed on an outer edge of the board.

7. An electric drive device comprising:
an electric motor unit having an electric motor, a motor housing that houses the electric motor, and a pedestal provided on one end in an axial direction of the motor housing; and
an electronic controller attached to the electric motor unit, the electronic controller controlling the electric motor unit,
wherein the electronic controller includes:
a board carrying an electronic circuit, the board being placed on the pedestal; and
a connector assembly disposed on one side in the axial direction of the board,
the board has a connection hole in which a coil wire of the electric motor unit is inserted, and
the connector assembly includes:
a flat plate portion that leaves one side in the axial direction of an area of the board open, the area including the connection hole, while covering a part of the board; and
a connector housing provided on the flat plate portion, the connector housing allowing a terminal of an external device to be inserted in the connector housing along the axial direction.

8. The electric drive device according to claim 7, wherein the connector housing is located within a projection plane of the motor housing and the pedestal when the electric motor unit is seen from one side in the axial direction.

9. The electric drive device according to claim 7, wherein the pedestal includes:
a bearing surface on which the board is mounted; and
a plurality of supports projecting further toward one side in the axial direction than the bearing surface and supporting the flat plate portion, and
the plurality of supports are arranged on an outer edge of the pedestal.

10. The electric drive device according to claim 9, wherein
the pedestal has a coil wire opening through which the coil wire is inserted, and
the plurality of supports are arranged such that a gap is formed between each support and each end of the coil wire opening.

11. The electric drive device according to claim 9, wherein the plurality of supports are arranged such that a space in which a jig for holding the coil wire is inserted is formed between the supports.

12. The electric drive device according to claim 10, wherein
a plurality of the connection holes are formed on an outer edge of the board,
the coil wire opening is formed on an outer edge of the pedestal, and
the plurality of coil wires of the electric motor are collectively inserted through the coil wire opening.

13. The electric drive device according to claim 12, wherein the plurality of coil wires and the board are connected to each other by a spot flow soldering method.

14. The electric drive device according to claim 7, wherein
the electronic controller includes a cover that covers the board and a part of the connector assembly,
the cover is fitted to one end in an axial direction of the motor housing by a caulking process, and
an O-ring is fitted to the motor housing or the pedestal, the O-ring being brought into close contact with an inner wall surface of the cover.

15. The electric drive device according to claim 14, wherein the cover is subjected to a caulking process on one side and the other side in the axial direction with respect to the O-ring.

16. The electric drive device according to claim 14, wherein a caulking recess in which the cover is pushed is formed on the motor housing or the pedestal.

17. The electric drive device according to claim 14, wherein
the cover includes:
a side surface in close contact with the O-ring, the side surface being subjected to a caulking process; and
a main surface extending continuously from one end in the axial direction of the side surface, the main surface having an opening from which the connector housing projects.

18. The electric drive device according to claim 17, wherein
the flat plate portion has a groove encircling the connector housing, and
a front end of the opening of the cover is fitted into the groove.

19. The electric drive device according to claim 18, wherein a sealant fills up a gap between the groove and a front end of the opening.

20. An electric power steering apparatus comprising an electric drive device that provides auxiliary torque to assist in turning/operating a steering wheel,
wherein the electric drive device includes:
an electric motor unit having an electric motor, a motor housing that houses the electric motor, and a pedestal provided on one end in an axial direction of the motor housing; and
an electronic controller attached to the electric motor unit, the electronic controller controlling the electric motor unit,
the electronic controller includes:
a board carrying an electronic circuit, the board being placed on the pedestal; and
a connector assembly disposed on one side in the axial direction of the board,
the board has a connection hole in which a coil wire of the electric motor unit is inserted, and
the connector assembly includes:
a flat plate portion that leaves one side in the axial direction of an area of the board open, the area including the connection hole, while covering a part of the board; and
a connector housing provided on the flat plate portion, the connector housing allowing a terminal of an external device to be inserted in the connector housing along the axial direction.
